(19) United States
(12) Patent Application Publication
(10) Pub. No.: US 2020/0361330 A1
(43) Pub. Date: Nov. 19, 2020

(54) METHOD FOR ESTABLISHING A COMMUNICATION CONNECTION BETWEEN A STATIONARY ELECTRIC CHARGING STATION AND A MOTOR VEHICLE, CONTROLLER AND CHARGING SYSTEM

(71) Applicant: AUDI AG, Ingolstadt (DE)

(72) Inventors: Reinhard PEER, Gaimersheim (DE); Sotirios SOTIRIOU, Mannheim (DE); Marnix LANNOIJE, Heidelberg (DE)

(73) Assignee: AUDI AG, Ingolstadt (DE)

(21) Appl. No.: 16/638,192

(22) PCT Filed: Aug. 28, 2018
(86) PCT No.: PCT/EP2018/073055

§ 371 Date: Feb. 11, 2020

(30) Foreign Application Priority Data
Sep. 13, 2017 (DE) 10 2017 216 127.2

(51) Int. Cl. B60L 53/36; B60L 53/66; B60L 53/37; B60L 53/38; H04W 4/40

(52) U.S. Cl. CPC B60L 53/36; B60L 53/66; H04W 4/40; B60L 53/38; B60L 53/37

(57) ABSTRACT

A method for providing a communication connection between a stationary electric charging station and a motor vehicle arranged in an environment of the charging station. The communication connection is established by a controller and trajectory data of a current approach trajectory of the motor vehicle are determined during an approach of the motor vehicle toward the charging station. At least one characteristic approach trajectory leading to the charging station is provided and compared with the current approach trajectory and, if the current approach trajectory fulfills a predetermined offset criterion regarding any characteristic approach trajectory, an alternating signal is generated which signalizes that the communication connection is dis-connected and a new communication connection should be established to a different charging station.

The invention relates to a method for providing a communication connection between a stationary electric charging station and a motor vehicle arranged in an environment of the charging station. The communication connection can be established, for example, to exchange identification data and/or position data between the motor vehicle and the charging station. The invention also includes a controller, which can be provided in the motor vehicle or the charging station, well as a charging system with several charging stations.

An electric charging station may be designed, for example, for inductive charging. In this case, it may be provided that the charging station has a base pad, in which the so-called primary coil is provided for inductive charging. A motor vehicle can then have, for example, a so-called secondary coil in the vehicle floor, it being possible to park or position said secondary coil over the base pad, i.e. over the primary coil. The transfer of energy according to the transformer principle is then possible in such a charging position. An electric battery of the motor vehicle can hereby be charged or recharged, for example, with electrical energy.

To ensure that a motor vehicle can automatically implement such an inductive charging process with a charging station, the correct positioning of the motor vehicle with respect to the base pad is necessary, i.e. the approach to the predetermined charging position. During this approach of the motor vehicle toward an inductive charging station, a wireless communication connection can be established between the motor vehicle and the charging station using radio technology. As a second step, a so-called positioning system, which determines the position of the motor vehicle with respect to the charging station then starts once the communication connection has been successfully established. For example, the current relative position of the motor vehicle with respect to the charging station can be provided to the driver of the motor vehicle or an autopilot system of the motor vehicle. The motor vehicle can then be maneuvered or guided into the predetermined charging position.

However, this does not exclude several charging stations being installed close to one another, for example at several adjacent parking spaces, in order to supply several motor vehicles accordingly. However, with such parking spaces having several charging stations, for example several base pads for inductive charging, it cannot be excluded that said wireless communication connection is established between the motor vehicle and a charging station which is not even positioned at the parking space activated by the driver of the motor vehicle. The relative position of the motor vehicle signalized by the positioning system of the contacted charging station in response is then displayed continuously, because the motor vehicle is not being maneuvered to this charging station at all. Such a flawed establishment of the communication connection to an unintended charging station must be recognized by the driver, for example, by means of comparison of the position data with the actually visible relative position of the motor vehicle with respect to the actually activated charging station.

DE 10 2014 223 931 A1 discloses a charging station which can automatically maneuver a motor vehicle to a charging station. To this end, the charging station must have, however, an expensive optical detection system with camera and image processing device.

DE 10 2014 221 559 A1 discloses a method for establishing a communication connection between a charging station and a motor vehicle. If there are several charging stations in the vicinity, the motor vehicle can detect which charging station is the closest and thus the charging station targeted by the motor vehicle by means of a signal strength of the radio signals of the individual charging stations. In addition, a trajectory of the motor vehicle can be evaluated, i.e. the driving direction and/or steering angle of the motor vehicle are used in order to detect which charging station the driver is currently approaching. The disadvantage with this method is that the environment of the charging stations must be mapped and known to the motor vehicle so that the motor vehicle can identify the activated charging station by means of its driving trajectory. This involves great complexity when installing the charging stations, because mapping of the environment is necessary.

DE 10 2014 222 000 A1 discloses a positioning system for exact positioning of a motor vehicle over a base pad of an inductive charging station. The system is camera-based. The system can only be activated once the motor vehicle is already located at least partially over the correct base pad.

The object of the invention is to verify that a motor vehicle approaching a charging station has established the communication connection to the correct charging station.

The object is achieved by the subject matters of the independent claims. Advantageous refinements of the invention result from the dependent claims, the following description, as well as the figures.

The invention provides a method for operating or establishing a communication connection between a stationary electric charging station and a motor vehicle arranged in an environment of the charging station. The charging station may be an inductive charging station, for example. In general, a charging station may also be provided, however, with a different charging technology. The communication connection can be provided, for example, to transfer identification data about the charging station and/or the motor vehicle. However, the communication connection may be provided so that the motor vehicle can be maneuvered to the charging station, in addition or as an alternative to the transfer of position data and/or navigation prompts. The method according to the present invention may be implemented by a controller. The controller establishes the communication connection and determines a current approach trajectory of the motor vehicle during an approach of the motor vehicle to the charging station. The communication connection can be established, for example, based on the principle of pairing. For example, the communication connection may be a Bluetooth connection such that Bluetooth pairing can be implemented to establish the communication connection. Said approach trajectory describes the trajectory of the motor vehicle during the approach. The approach trajectory may be a sequence of successively measured or recorded vehicle positions.

If the vehicle then establishes a communication connection with a charging station that is different than the charging station actually being approached, the approach trajectory will not lead to the particular charging station to which the communication connection has also been established.

In order to detect and correct this, the invention provides for at least one characteristic approach trajectory leading to the charging station. In other words, trajectory data are provided or stored regarding at least one expected or typical approach trajectory. The controller then compares the at least one characteristic approach trajectory with the current approach trajectory of the motor vehicle currently approaching or coming closer. If the current approach trajectory fulfills a predetermined offset criterion regarding any provided characteristic approach trajectory, i.e. does not match any provided characteristic approach trajectory, an alternating signal is generated which signalizes that the communication connection should be disconnected and a new communication connection should be established to a different charging station. In other words, the communication connection to the current charging station is disconnected or rejected, because the current approach trajectory of the motor vehicle does not match this charging station, i.e. does not match any characteristic approach trajectory within a predetermined tolerance.

The invention provides for the advantage that the driver does not have to check whether there is a contradiction between the charging station, with which the motor vehicle has established the communication connection, and the approach trajectory of the motor vehicle. In an advantageous manner, there is an automatic disconnecting of the communication connection in the event of incorrect pairing, i.e. in the event of a contradiction between the approached charging station and the charging station to which the communication connection has been initially established.

The invention also comprises additional embodiments, which result in additional advantages.

According to one embodiment, the at least one characteristic approach trajectory is formed from historical trajectory data of approach trajectories of such previous vehicles which have been successfully coupled with the charging station for an energy exchange in the past after traveling the respective approach trajectory. Previous vehicles are motor vehicles which have successfully approached, up to the point of coupling for the exchange of energy, in the past at least once with an approach trajectory of the charging station. Their trajectory data are then used to form the at least one characteristic approach trajectory. This hereby results in the advantage that the charging station can calibrate itself after installation. Thus, no complex mapping of the environment of the charging station is necessary in order to describe or provide the at least one characteristic approach trajectory. Several characteristic approach trajectories may result when the charging station can be approached from multiple different directions. By means of a differentiation criterion, the trajectory data of several different approach trajectories can then be grouped. Each group of approach trajectories can then be combined into a characteristic approach trajectory, e.g. a mean approach trajectory, for example, through statistical methods (for example as the arithmetic mean).

One embodiment provides that the current approach trajectory of the motor vehicle currently approaching is determined by means of an odometry system of the respective motor vehicle and/or by means of a camera and/or by means of a radio direction finding system. An odometry system has the advantage that it is easily available onboard in a motor vehicle. There is only a relative evaluation with an odometry system, i.e. characteristic driving maneuvers such as steering and/or accelerations and/or braking and/or a driving speed are used to describe the current approach trajectory. The radio direction finding system has the advantage that it is independent from the visibility conditions.

With reference to the radio direction finding system, one embodiment of the invention provides that a transmitter of the radio direction finding system transmits a transmit signal and at least two receivers of the radio direction finding system receive the transmit signal. For example, the transmitter may be arranged on the motor vehicle. The two receivers may be a component of the charging station or be arranged in a fixed position relative to the charging station. A respective signal strength of the transmit signal to the receivers is then determined and, by means of the determined signal strengths, a relative position of the transmitter with respect to the at least two receivers is then determined by means of trilateration. This results in the advantage that radio direction finding or positioning of the motor vehicle is enabled without image processing. The signal strength provides information on the distance between the transmitter and the respective receiver. In addition, the distance between the receivers is known. If a circle is then drawn around the receivers with the radius corresponding to the distance of the transmitter or the signal strength, a point of intersection of the circles thus provides the position of the transmitter. Although this form of trilateration is ambiguous, the ambiguous solution can be excluded using simple means based on the structural environment around the charging station, for example during installation of the charging station. There is normally also a position specification in front of and behind the charging station. The position specification behind the charging station can then be excluded.

One embodiment provides that said offset criterion, by means of which a difference is evaluated between the current approach trajectory and a characteristic approach trajectory, comprises the following condition. The offset criterion is fulfilled when the motor vehicle moves and is offset at least by a predetermined minimum distance to the respective characteristic approach trajectory. In other words, the motor vehicle travels along the curve of the characteristic approach trajectory and, in doing so, has at least one predetermined minimum distance. The minimum distance may be greater than one meter. The minimum distance may be dependent on location. This offset criterion enables the determination as to when a motor vehicle is being maneuvered not to the parking space of the current charging station but instead to an adjacent parking space.

One embodiment provides that, together with generating the alternating signal, the trajectory data determined to this point of the current approach trajectory of the motor vehicle are provided to a controller of the other charging station. In other words, the trajectory data are not rejected but instead the other controller, with which the motor vehicle establishes a new communication connection after the alternating signal, also receives the trajectory data of the current approach directly traveled up to then. Thus, the other controller can continue the verification of the approach trajectory, in an advantageous manner, at the location at which it was interrupted by the current controller, because the offset criterion was fulfilled.

One embodiment provides that the approach to a charging pad leads to inductive charging of the motor vehicle. In other words, the method is preferably implemented in context with a charging pad for inductive charging. The charging pad may have the secondary coil for inductive charging in the described manner.

One embodiment provides that the respective wireless communication connection is provided as a Bluetooth connection or WLAN connection (WLAN—wireless local area network). This hereby results in the advantage that the range of the communication connection can be limited to a range that is suitable for an approach. In other words, unnecessary disruption of other charging stations can be avoided, because the wireless range is limited. For example, the detection of the approach, i.e. the measuring of the approach trajectory is started beginning at a distance that is less than 100 meters, particularly less than 50 meters.

In order to implement the method according to the invention, said controller is provided by the invention. The controller may be provided for a motor vehicle or a charging station or as a device distributed partially for a motor vehicle and partially for a charging station. The controller has a processor unit, which is configured to implement an embodiment of the method according to the invention. To this end, the processor unit may have at least one microprocessor and/or at least one microcontroller. The processor unit may have a program code, which is configured to implement the embodiment of the method according to the invention upon execution by the processor unit. The program code can be stored in a data memory of the processor unit. The controller may be designed, for example, as a control unit or control circuit.

Because the method is particularly reliable when several charging stations are provided next to one another or adjacent one another, the invention accordingly comprises as well a charging system with several electric charging stations in order to exchange electrical energy with a motor vehicle. Each of the charging stations of the charging system in this case has an embodiment of the controller according to the invention. Upon establishment of a communication connection of a motor vehicle to one of the charging stations and a subsequent approach to a different charging station, this hereby results in the advantage that the communication connection can then be automatically disconnected and the communication connection instead can be established with the other charging station.

An exemplary embodiment of the invention is described in the following. The following is shown:

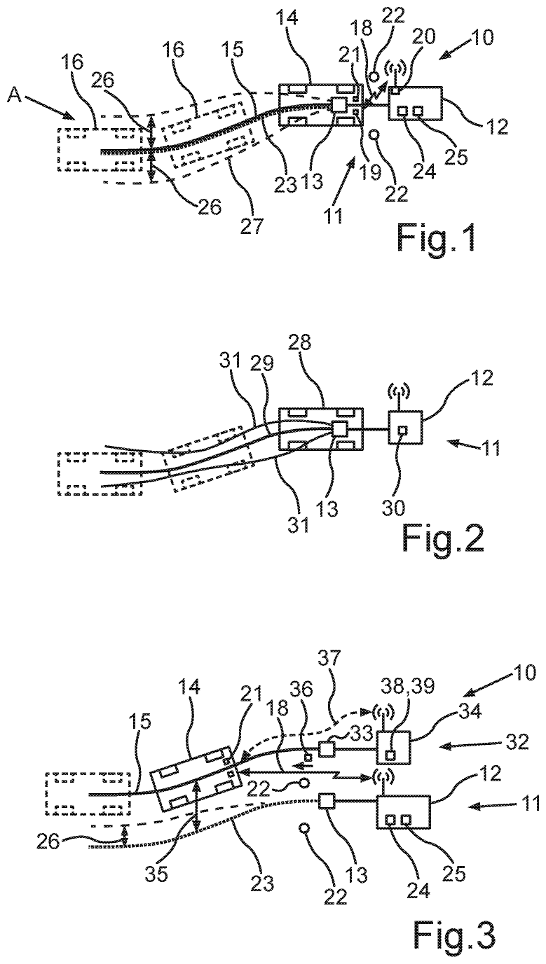

FIG. 1 a schematic representation of an embodiment of the charging system according to the invention;

FIG. 2 a diagram to illustrate the formation of a characteristic approach trajectory; and

FIG. 3 a diagram to illustrate an approach of a motor vehicle which has established a communication connection with an incorrect controller.

The exemplary embodiments explained in the following refer to preferred embodiments of the invention. With the exemplary embodiments, the described components of the embodiments represent individual features of the invention that are to be considered independently of one another, each of which also further develop the invention independently of one another and thus also are to be considered individually or in a combination that is different than the one shown as a component of the invention. Furthermore, the described embodiments can also be supplemented through further described features of the invention.

In the figures, elements which are functionally equivalent are each given the same reference numerals.

FIG. 1 shows a charging station 11 with a controller 12 and a charging pad 13 of a charging system 10. The charging pad 13 may be installed in the ground of a parking space. A motor vehicle 14 may have been maneuvered to the parking space by a driver, for example, for an inductive charging process at the charging pad 13 such that the motor vehicle 14 is parked or arranged over the charging pad 13 with a secondary coil of the motor vehicle 14. In this case, the motor vehicle 14 may have been guided along an approach trajectory 15 by the driver. The previous positions 16 of the motor vehicle 14 along the approach trajectory 15 are likewise shown in FIG. 1 for the sake of clarity.

For the approach A illustrated here, the motor vehicle 14 may have established a wireless communication connection 18 with the controller 12. To this end, the motor vehicle 14 may have a wireless module 19 and the controller 12 may have a wireless module 20. The communication connection 18 may have been established, for example, as a Bluetooth connection or WLAN connection by means of the wireless modules 19, 20. In order to detect the approach trajectory 15, it may be provided, for example, that the motor vehicle 14 has a transmitter 21 for a wireless signal. Receivers 22 may be arranged fixed in position at the charging station 11. The transmitter 21 and the receiver 22 represent a radio direction finding system. A wireless signal of the transmitter 21 reaches the receivers 22 with the respective signal strength which represents an instruction or information regarding a respective distance between the transmitter 21 and the respective receiver 22. A relative position of the transmitter 21 can hereby be determined with respect to the receivers 22. By means of a sequence of positions of the transmitter 21, the approach trajectory 15 may be determined by the controller 12 or the motor vehicle 14.

Furthermore, a characteristic approach trajectory 23 may be stored in the controller 12 in the form of trajectory data 24. The curve of the characteristic approach trajectory 23 is shown in FIG. 1. The controller 12 can compare the curve of the current approach trajectory 15 with the characteristic approach trajectory 23. In doing so, an offset criterion 25 can be verified which can specify, for example, that the current approach trajectory 15 must be within a predetermined minimum distance 26 to the characteristic approach trajectory 23. This hereby results, as a whole, in a passage 27, within which the approach trajectory 15 must occur. In this case, the minimum distance 26 can be defined as a function of a distance with respect to the base pad 13.

FIG. 1 shows a situation in which the offset criterion 25 remains unfulfilled, i.e. the approach trajectory 15 has a small offset with respect to the characteristic approach trajectory 23 such that the controller 12 determines that the motor vehicle 14 is moving onto the charging pad 13 which is assigned to the controller 12. As soon as the motor vehicle 14 has a predetermined relative position with respect to the charging pad 13, an inductive charging process can be triggered or started.

FIG. 2 shows how the trajectory data 24 of the characteristic approach trajectory 23 can be determined by the controller 12.

A situation is shown that has taken place chronologically before the situation according to FIG. 1. A motor vehicle, which is characterized as the preceding motor vehicle 28 here, has successfully completed an approach to the charging pad 13 along an approach trajectory 29. The controller 12 may have determined or recorded trajectory data 30 of this approach trajectory 29 in the described manner. Furthermore, it is also shown that respective approach trajectories 31 may also have been detected and stored as trajectory data 30 by other (not shown) proceeding vehicles. An average approach trajectory, for example, which can then be used as the basis for the characteristic approach trajectory, can then be calculated from the trajectory data 30.

FIG. 3 shows how the controller 12 may respond when the offset criterion 25 has been fulfilled.

To this end, a situation different than that in FIG. 1 is shown, in which the motor vehicle 14 actually has the communication connection 18 to the controller 12 but is moving to a different charging station 32 in order to use its charging pad 33 for a charging process. In other words, the communication connection 18 actually must have been established with a different controller 34, namely the controller 34 of charging station 32. The controller 12 determines, for example based on the transmitter 21 and the receiver 22, the approach trajectory 15 of the motor vehicle 14 in the described manner and determines that there is a distance or offset 35 between the current approach trajectory 15 and the characteristic approach trajectory 23 which is greater than the minimum distance 26. Thus, this fulfills the offset criterion 25.

When the offset criterion 25 is fulfilled, the controller 12 can generate an alternating signal 36 and notify the motor vehicle 14 of the communication connection 18. As a function of or upon receipt of the alternating signal 36, the motor vehicle 14 can disconnect the communication connection 18 and establish a new communication connection 37 to the other controller 34 of the other charging station 32. Thus, the other controller 34 can then compare the current approach trajectory 15 with such a characteristic approach trajectory 38, the trajectory data 39 of which has been stored in the controller 34. The controller 12 in this case can then transfer or transmit the previously recorded trajectory data of the approach trajectory 15 to the controller 34.

In this case, a spatial offset can be calculated or considered between controllers 12, 34. Thus, the controller 34 can use the trajectory data of the previously driven approach trajectory 15 for checking its own offset criterion.

After the pairing of the motor vehicle 14 with the charging station 11, an off-line approach trajectory or characteristic approach trajectory 23 can thus be stored in the charging station 11 for the parking space of this charging station. Due to this characteristic approach trajectory then stored for this charging station 11, it is possible for the control electronics system of the controller 12 to detect a potential unsuccessfully established communication connection 18 (refer to the situation in FIG. 3) and to initiate active verification of other inductive charging stations 32.

Altogether, the examples show how the invention can optimize multi-pad handling for several charging pads during inductive charging of electric vehicles.

1-10. (canceled)

11. A method for providing a communication connection between a stationary electric charging station and a motor vehicle arranged in an environment of the charging station, comprising:
the communication connection is established by a controller and trajectory data of a current approach trajectory of the motor vehicle are determined during an approach of the motor vehicle toward the charging station, wherein at least one characteristic approach trajectory leading to the charging station is provided and compared with the current approach trajectory and, if the current approach trajectory fulfills a predetermined offset criterion regarding each characteristic approach trajectory, an alternating signal is generated which signalizes that the communication connection is disconnect-ed and a new communication connection is to be established to a different charging station.

12. The method according to claim 11, wherein the at least one characteristic approach trajectory is formed from historical trajectory data of approach trajectories of previous vehicles which have been successfully coupled with the charging station for an energy exchange in the past after traveling the respective approach trajectory.

13. The method according to claim 11, wherein the current approach trajectory is determined by an odometry system of the respective motor vehicle and/or by a camera and/or by a radio direction finding system.

14. The method according to claim 13, wherein a transmitter of the radio direction finding system transmits a transmit signal and at least two receivers of the radio direction finding system receive the transmit signal, and a respective signal strength of the received transmit signal is determined and, by the determined signal strengths, a relative position of the transmitter with respect to the at least two receivers is then determined by trilateration.

15. The method according to claim 11, wherein the offset criterion includes the condition that the motor vehicle moves and is offset by at least a predetermined minimum distance to the respective characteristic approach trajectory.

16. The method according to claim 11, wherein, together with generating the alternating signal, the trajectory data determined to this point of the current approach trajectory of the motor vehicle are provided to the other charging station.

17. The method according to claim 11, wherein the approach to a charging pad leads to inductive charging of the motor vehicle.

18. The method according to claim 11, wherein the respective communication connection is provided as a Bluetooth connection or WLAN connection.

19. A controller for a motor vehicle or a charging station, wherein the controller has a processor unit, which is configured to implement provide a communication connection between a stationary electric charging station and a motor vehicle arranged in an environment of the charging station, comprising:
the communication connection is established by a controller and trajectory data of a current approach trajectory of the motor vehicle are determined during an approach of the motor vehicle toward the charging station, wherein at least one characteristic approach trajectory leading to the charging station is provided and compared with the current approach trajectory and, if the current approach trajectory fulfills a predetermined offset criterion regarding each characteristic approach trajectory, an alternating signal is generated which signalizes that the communication connection is disconnect-ed and a new communication connection is to be established to a different charging station.

20. A charging system with several electric charging stations in order to exchange electrical energy with a motor vehicle, wherein each of the charging stations has a controller configured to provide a communication connection between a stationary electric charging station and a motor vehicle arranged in an environment of the charging station, comprising:
the communication connection is established by a controller and trajectory data of a current approach trajectory of the motor vehicle are determined during an approach of the motor vehicle toward the charging station, wherein at least one characteristic approach trajectory leading to the charging station is provided and compared with the current approach trajectory and, if the current approach trajectory fulfills a predetermined offset criterion regarding each characteristic approach trajectory, an alternating signal is generated which signalizes that the communication connection is disconnect-ed and a new communication connection is to be established to a different charging station.
